(19) United States
(12) Patent Application Publication
(10) Pub. No.: US 2010/0015340 A1
(43) Pub. Date: Jan. 21, 2010

(54) COMPOSITIONS AND METHODS FOR THE MANUFACTURE OF RARE EARTH METAL-Ba2Cu3O7-delta THIN FILMS

(75) Inventors: Paul Clem, Albuquerque, NM (US); Cynthia Edney, Sandia Park, NM (US); Donald Overmyer, Albuquerque, NM (US); Michael Siegal, Albuquerque, NM (US); Jeffrey Dawley, San Jose, CA (US); Michael Backer, Koln (DE)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: ZENERGY POWER INC., South San Francisco, CA (US); SANDIA CORPORATION, Albuquerque, NM (US)

(21) Appl. No.: 12/174,970

(22) Filed: Jul. 17, 2008

(51) Int. Cl. B05D 3/02; C09D 1/00

(52) U.S. Cl. 427/372.2; 106/1.23; 524/413

(57) ABSTRACT

Compositions and methods for making rare earth metal-Ba₂Cu₃O_{7-δ} films are described. The composition includes a barium (Ba) metal-organic compound, one or more rare earth metal organic compounds and a copper (Cu) metal-organic compound. The composition also includes a halogen. For example, the composition can include a halogenated organic solvent. The composition also includes a solvent having a boiling point greater than approximately 230° C. The precursor solution can also include a low-viscosity solvent that does not react with the halogenated solvent to produce water. A high-viscosity compound can also be included to enable the formation of thicker films. The resulting precursor solution can be deposited on a substrate, pyrolyzed at a heating rate greater than 50° C./minute, and crystallized to produce smooth, sheer films. Films greater than 100 nm in thickness can be produced with transport J_{c} values of 4×10⁶ A/cm² at 77° K on various substrates.

### STATEMENT REGARDING FEDERALLY SPONSORED RESEARCH OR DEVELOPMENT

This invention was developed under Contract No. DE-AC04-94AL85000 between Sandia Corporation and the United States Department of Energy. The United States Government has certain rights in the invention.

The section headings used herein are for organizational purposes only and should not be construed as limiting the subject matter described herein in any way.

### BACKGROUND

1. Field

This application relates generally to methods of making films of rare earth metal oxides.

2. Background of the Technology

Even though the electrical resistance of metallic conductors, such as Cu or Ag, is small, at least 20% of all power generated in the U.S. is lost before it ever reaches the consumer. One possible solution is the development of thin, superconducting tapes that can be woven into high-power transmission cables. YBa₂Cu₃O_{7-δ} (YBCO) is one potential material that can be used. YBCO has a transport current density (J_{c}) above 10⁶ A/cm² at 77° K on single crystal and buffered metal substrates for c-axis epitaxial YBCO thin films.

Chemical solution deposition (CSD) is a technology for fabricating long lengths of YBCO tapes at low cost. Ex situ CSD methods are readily suitable for continuous processing via dip-coating, web-coating, or spray-coating (McIntyre et al., Appl. Phys., 1990, 68, 4183-4187; Nonaka et al., Jpn. J. Appl. Phys. Pt. 2, 1988, 27, L867-L869; Manabe et al., Physica C, 1997, 276, 160-166; and Yamagaiwa et al., J. Cryst. Growth, 2001, 229, 353-357. McIntyre et al. has developed a standard method for making high-quality YBCO thin films by CSD. The method involves the dissolution of Ba, Y and Cu carbonates in trifluoroacetic acid. The solution is dried, then diluted with methanol to the desired molarity. High-quality, phase-pure YBCO films with current density (J_{c}) values greater than 3×10⁶ A/cm² at 77K have been fabricated by this method.

In the method described by McIntyre et al. and other similar variants, the decomposition of the metal trifluoroacetates, especially the Cu-trifluoroacetate, is very exothermic in air or O₂. If heated too rapidly, a run-away decomposition of the organics in the film can occur, which destroys the integrity of the film. As a result, a very slow pyrolysis stage (typically requiring 8-12 hours) is required to control the decomposition. Water vapor is often added to the furnace gas to help prevent the loss of Cu during pyrolysis, so that proper cation stoichiometry can be maintained. It has been shown that a low pO₂ (0.2-1% O₂) pyrolysis can effectively control the organic decomposition and composition of CSD YBCO thin films while requiring only 1.5 hours for the pyrolysis stage (Dawley et al., J. Mater. Res., 2001, 16, 13-16 and Dawley et al., IEEE Trans. Appl. Superconductivity, 2001, 2873-2876). A pyrolysis stage is defined herein as a heat treatment step where the organic species present in a film after deposition onto a substrate are at least partially decomposed by thermal means. Films fabricated by this method had equivalent electrical properties to those pyrolyzed in air or O₂. However, film morphology of films processed by this method was found to have a “pencil maze” pattern, unlike the smooth, sheer films of McIntyre et al. Because the height of the peaks in the structure of the films with this pencil maze pattern are several times larger than the valleys, the formation of the pencil maze structure prevents the deposition of additional continuous layers, thereby being an almost insurmountable obstacle for making thicker films by multi-layering. Approximately 10-20 layers are needed to make a thick enough superconducting layers for most power applications.

Accordingly, there exists a need for chemical solution deposition processes that enable the fabrication of smooth, phase-pure, epitaxial films of rare earth metal oxides such as YBCO with reduced processing times.

### SUMMARY

A composition is provided which comprises:

a barium metal-organic compound;

one or more rare earth metal-organic compounds;

a copper metal-organic compound;

a high-boiling solvent having a boiling point greater than 230° C. at atmospheric pressure;

wherein the composition further comprises a halogenated organic solvent and/or wherein one or more of the barium metal-organic compound, the one or more rare earth metal-organic compounds and the copper metal-organic compound comprises a halogen;

wherein the molar ratio of high-boiling solvent to rare earth metal in the composition is 1-10:1; and

wherein the molar ratio of barium to rare earth metal in the composition is less than 2.1:1 and wherein the molar ratio of copper to barium in the composition is greater than 3:2.

A method of making a rare earth metal Ba₂Cu₃O_{7-δ} film wherein δ is 0 to 1 inclusive, is also provided which comprises:

a) coating a composition of as set forth above onto a substrate;

b) subsequently heating the composition at a rate of at least 50° C./minute to cause organic decomposition thereby forming a pyrolyzed precursor on the substrate;

c) subsequently reacting the pyrolyzed precursor into a rare earth metal Ba₂Cu₃O_{7-δ} film.

A composition is also provided which comprises:

a barium metal-organic compound;

one or more rare earth metal-organic compounds;

a copper metal-organic compound;

wherein the composition further comprises a halogenated organic solvent and/or wherein one or more of the barium metal-organic compound, the one or more rare earth metal-organic compounds and the copper metal-organic compound comprises a halogen;

a high-boiling solvent having a boiling point greater than 230° C. at atmospheric pressure; and

a low-viscosity solvent having a viscosity of less than 10 centipoise at 20° C.;

wherein the low-viscosity solvent does not react with the halogenated organic solvent to form H₂O.

A method of making a rare earth metal Ba₂Cu₃O_{7-δ} film wherein δ is 0 to 1 inclusive, is also provided which comprises:

a) coating a composition of as set forth above onto a substrate;

b) subsequently heating the composition at a rate of at least 50° C./minute to cause organic decomposition thereby forming a pyrolyzed precursor on the substrate;

c) subsequently reacting the pyrolyzed precursor into a rare earth metal Ba₂Cu₃O_{7-δ} film.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 shows an electron microscope image of a 1400-nm thick c-axis YBCO film made from a DEA-containing solution on a SrTiO₃ coated NiW substrate.

FIG. 2 shows an x-ray diffraction file of a vacuum crystallized, TFA-DEA-Acetone precursor-derived epitaxial YBCO film on a CeO₂/La₂Zr₂O₇ coated Ni_{0.95}W_{0.05} substrate.

FIG. 3 shows an x-ray diffraction file of a vacuum crystallized, TFA-DEA-Acetone precursor-derived epitaxial YBCO film on a SrTiO₃-coated Ni_{0.95}W_{0.05} substrate, where both the YBCO and SrTiO₃ film were coated at 30 meters/hour.

FIGS. 4A, 4B and 4C show x-ray diffraction pole figures illustrating biaxial texture of NiW substrates (FIG. 4A) and subsequent SrTiO₃ (FIG. 4B) and YBCO (FIG. 4C) films.

### DESCRIPTION OF THE VARIOUS EMBODIMENTS

For the purposes of interpreting this specification, the use of “or” herein means “and/or” unless stated otherwise or where the use of “and/or” is clearly inappropriate. The use of “a” herein means “one or more” unless stated otherwise or where the use of “one or more” is clearly inappropriate. The use of “comprise,” “comprises,” “comprising,” “include,” “includes,” and “including” are interchangeable and not intended to be limiting. Furthermore, where the description of one or more embodiments uses the term “comprising, ” those skilled in the art would understand that, in some specific instances, the embodiment or embodiments can be alternatively described using the language “consisting essentially of” and/or “consisting of.” It should also be understood that, in some embodiments, the order of steps or order for performing certain actions is immaterial so long as the present teachings remain operable. Moreover, in some embodiments two or more steps or actions can be conducted simultaneously.

Solution-based deposition methods for producing complex oxides such as YBa₂Cu₃O_{7-δ} (YBCO) have been previously developed to incorporate multiple elements, provide good control of local stoichiometry and allow for large-area deposition. However, available methods generally require at least 12-24 hours for processing to produce smooth, phase-pure, epitaxial c-axis YBa₂Cu₃O_{7-δ} (YBCO) films.

In a chemical solution-based deposition (CSD) process for making YBCO films the precursor solution can be prepared by dissolving a barium (Ba) metal-organic compound in a halogenated organic solvent and then adding a yttrium (Y) metal-organic compound and a copper (Cu) metal-organic compound. Other rare earth metal organic compounds can be used either in place of or in combination with the Yttrium metal-organic compound to produce oxide films having a desired composition. Other rare earth metal compounds that can be used include, but are not limited to, compounds of Gd, Sm and Nd. Non-limiting examples of the organic portion of any of the metal-organic compounds include carboxylates, neodeconates, alkoxides, amides, acetylacetates, tartrates, citrates, lactones, aldehydes, amines and hydroxyethers. Examples of halogenated organic solvents include, but are not limited to, primary, secondary and tertiary alcohols, ketones, aliphatic ketones, aromatic hydrocarbons, heterocyclics, hydroxyethers, glycol, and carboxylic acids, where one or more of the bound hydrogen atoms is replaced with a halogen atom, such as fluorine, bromine, iodine, or chlorine. The halogenated organic solvent can be an acid such as trifluoroacetic acid (TFA). As the solvent is removed from a CSD film during the deposition process, the film becomes more rigid as a gel network forms. Once the gel network is established, the film cannot easily adjust to external or internal stresses. In the case of a low partial-pressure O₂ process, the highest stress state likely occurs when the Cu loss from the film is highest due to Cu precursor volatility.

A high-boiling point solvent, such as diethanolamine (b.p. 247° C.), triethanolamine (b.p. 335° C.) and glycerine (b.p. 290° C.), can be added to the precursor solution to prevent the formation of the pencil maze structure to produce smooth, shear films after the pyrolysis. Various lower-boiling-point solvents can also be added to the precursor solution, including solvents with boiling points less than approximately 230° C., such as methanol (b.p. 68° C.), ethanolamine (b.p. 171° C.), acetylacetone (b.p. 141° C.), ethylene glycol (b.p. 198° C.), formamide (b.p. 211° C.) and propanediol (b.p. 213° C.).

Diethanolamine not only has a high boiling point that produces high-quality material, but also appears to complex with the Cu precursor to aid with solubility, dissolution, and Cu precursor stability during pyrolysis. Crystallized YBCO films made with DEA-containing solutions are phase-pure YBCO and exhibit excellent superconducting properties with transport J_{c} values of 4×10⁶ A/cm² at 77° K on various substrates.

In one embodiment, a precursor solution for a YBCO film can be made by dissolving Ba-acetate (approximately 99% pure) in trifluoroacetic acid (TFA) at a temperature of approximately 60-70° C. Y-acetate tetrahydrate (approximately 99.9% pure) and anhydrous Cu-acetate (approximately 99% pure) can then be added to yield an acetate/TFA precursor solution. A high-boiling solvent, for example diethanolamine (DEA), and a low-viscosity solvent (e.g., acetone) can then be added to formt he precursor solution.

The low-viscosity solvent (e.g., acetone) can be added to dilute the precursor solution. According to some embodiments, the low-viscosity solvent does not react with the halogenated solvent to produce water (e.g., via an esterification reaction). For example, methanol, which has been used previously as a low-viscosity solvent in YBCO processes using TFA, can react with the TFA to form water [trifluoracetic acid (CF₃COOH)+methanol (CH₃OH)→methyltrifluoroacetate (CF₃COOCH₃)+H₂O]. Other solvents that do not react with the halogenated organic solvent that produce water can be used instead of acetone, including primary, secondary and tertiary alcohols, ketones, aliphatic ketones, aromatic hydrocarbons, heterocyclic solvents, like tetrahydrofuran and pyridine, hydroxyethers, and glycols.

The resulting precursor solution can then be deposited onto a substrate. Exemplary substrates include, but are not limited to, (100) LAO and (100) SrTiO₃-buffered (100) Ni (either single crystal or polycrystalline Ni, like rolling-assisted, biaxially-textured (RABiT) Ni) substrate. Other possible substrate or buffer layer materials include oxides, nitrides, and metals that possess crystalline lattice parameters or crystallographic planes within their crystal structures, where c-axis YBCO can be grown in a heteroepitaxial manner parallel to the surface of the buffer layer or substrate material. The buffer layer architecture on metallic substrates may consist of doped or undoped aluminates, titanates, zirconates, manganates, niobates, rare earth oxides, magnesium oxide and combinations thereof. Examples of substrate or buffer layer materials include MgO, Ho₂O₃, Gd₂O₃, Er₂O₃, La₂Zr₂O₇, La_{0.7}Sr_{0.3}MnO₃, BaZrO₃, CeO₂, NaNbO₃, Y₂O₃—ZrO₂, III-V nitrides, Ni, Ag, and Cu.

Continuous solution deposition processes can be used. Examples of continuous deposition methods include, but are not limited to, dip-coating, aerosol misting, and spraying.

Excess solution can then be spun off using standard techniques, such as a photoresist spin-coater.

The coated substrates can then be heated (e.g., to over 100° C.) to dry. Possible heating methods include, but are not limited to, placement on a hot-plate, in an oven, or infra-red (IR) heating.

The as-deposited films can then be pyrolyzed. For example, the as-deposited films can be pyrolyzed to approximately 250-400° C. using a rapid, low PpO₂ process (Dawley et al., J. Mater. Res., 2001, 16, 13-16). The as-deposited films can also be pyrolyzed in air to approximately 300-400° C.

The pyrolyzed films can then be crystallized at elevated temperatures (e.g., approximately 700-900° C. for approximately 30 minutes). A humid (e.g., dewpoint of approximately 20° C.) 0.1%-100% oxygen (the balance being nitrogen or a noble gas, like Ar) atmosphere can be utilized for crystallization by bubbling the furnace gas through room-temperature water. The films can be held at a constant temperature during cool-down to achieve full oxidation of the film. For example, the film can be held for 30-minutes at 525° C. during cool-down in dry O₂ to achieve full oxidation of the film.

The absolute pressure used for pyrolysis and crystallization can be atmospheric pressure. The entire processing time, defined as the time span required to take a film from the as-deposited state to fully crystallized YBCO, can be approximately 1.5 to 3.5 hours. Crystallization can also be conducted at pressures less than atmospheric pressure (e.g., at pressures less than 0.1 atm.).

Subsequent analysis of YBCO films made by a process as described above using Cu K_{α} x-ray diffraction (XRD), Raman spectroscopy, scanning electron microscopy, waver stress measurement techniques, and profilometer techniques, showed that phase-pure, smooth, YBCO films can be produced with thicknesses of up to 500 nm.

Transport J_{c} values of such YBCO layers at 77° K are as high as 4×10⁶ A/cm². Compared with YBCO films made without DEA, the crystalline quality of the films was improved, based on a higher superconducting transition temperature (T_{c}).

According to some embodiments, a YBCO precursor solution can be made by dissolving Ba-acetate in the halogenated organic solvent trifluoroacetic acid (TFA) at 60-70° C. Y-acetate tetrahydrate and anhydrous Cu-acetate can then be subsequently added to yield a 0.6 M (mol YBCO/liter) solution with 1:2:(3+x) (Y:Ba:Cu) molar ratios, where x represents an extra amount of Cu added to the solution (approximately 0.1 mole). Diethanolamine and then a low viscosity solvent, such as acetone, which does not react with the TFA to produce water can then be added to create the final YBCO precursor solution (0.15-0.3 M).

This solution chemistry formulation for rapid fabrication of YBCO films is differentiated from standard (low boiling-point solvent, slower pyrolysis rate, esterification-reaction susceptible) TFA-based solution routes.

The precursor solutions can then be deposited onto various flexible tape substrates (e.g., SrTiO₃-coated NiW and CeO₂/La₂Zr₂O₇-coated NiW) at rates as high as 10 to 90 meters per hour. The film can be deposited by dip coating the oxide-coated metal substrates through a liquid reservoir of the precursor solution at 10 to 90 meters/hour, then drawing the tapes through a 1 meter furnace held at approximately 325° C. (e.g., residence time of 6 minutes to 40 seconds, respectively). The heating rates during pyrolysis can be approximately 100° C./min. The films can then be crystallized using a high heating rate (e.g., 740-780° C. for 2 to 30 min.) under a humid 70 ppm O₂/bal. N₂ atmosphere at a total pressure of 1 to 70 Torr. A 30 min. hold at 525° C. and 700 Torr, during the cool-down, in dry O₂ can be used to allow full oxidation of the YBCO. The absolute pressure for the pyrolysis and crystallization stages can be atmospheric pressure.

The resulting YBCO film thicknesses can be from 200 to 350 nm, depending on solution molarity. For these film thicknesses and 2-30 minute reaction times, reaction rates of the YBCO can range from 30 Angstroms/second to 2 Angstroms/second. J_{c} values for these films can be calculated using the critical state model, with the appropriate geometrical factors.

A YBCO precursor solution consisting of metal acetates, trifluoroacetic acid, a non-esterifying solvent (i.e., a solvent that does not react with TFA), and a DEA additive can be dip-coated rapidly (e.g., <2 minutes) heated to >290° C., and then crystallized at a rate of >10 Angstroms/second to fabricate high-quality, smooth YBCO films using a low pO₂ atmosphere pyrolysis. The DEA additive appeared to prevent film buckling by relaxing stress gradients that develop in the film. The stress gradients can be attributed to the sublimation of Cu metalorganic species in a low pO₂ ambient.

Experimentation has shown that use of the methods described herein can have a dramatic effect on thermal decomposition behavior of films pyrolyzed in air or other oxidizing atmospheres. In fact, using the methods described herein can permit a very fast pyrolysis (e.g., seconds vs. hours without a high-boiling solvent such as DEA) in air without loss of film integrity and little to no reduction in superconducting properties upon crystallization.

Differential thermal analysis (DTA) and thermal gravimetric analysis (TGA) data were obtained for dried YBCO gels fabricated from the same precursor solution without DEA and with DEA. The thermal decomposition processes were clearly different for the two gels. The DTA of the gel without DEA displayed a single exotherm, indicating an almost simultaneous thermal decomposition of the three (Y, Ba, and Cu) metal-fluoroacetates. The onset of the organic decomposition was approximately 240° C., which is consistent with the decomposition of Cu-fluoroacetate. However, the decomposition was complete by 320° C., which is well below the expected decomposition temperatures for Y— or Ba-fluoroacetate (i.e., 350° C. and 450° C., respectively). TGA shows only a single weight loss event between 240° C. and 320° C., and no further weight loss at higher temperatures. This indicates that all of the organic species have decomposed by 320° C. These observations suggest that the Cu-fluoroacetate decomposition catalyzes the decomposition of the Y— and Ba-fluoroacetates at lower temperatures.

The YBCO precursor gel fabricated with DEA displays two exotherms. The first exotherm has an onset at 240° C., which is consistent with the decomposition of Cu-fluoroacetate. TGA observes rapid weight loss with the onset of the decomposition. The Cu-fluoroacetate decomposition reaction is completed by 270° C. From 270 to 320° C., DTA indicates no significant reactions. However, the gel continues to lose weight. Since the boiling point of DEA is 268° C., this weight loss is likely due to the evaporation of DEA. A second decomposition reaction begins at 320° C. and is complete by 400° C. Subsequent analysis of single and paired cation gels indicates that the second exotherm is probably due to the thermal decomposition of the Y— and Ba-fluoroacetates. The decomposition apparently occurs as a single exotherm, because the Y and Ba are present as a mixed (Ba,Y)(O,F) oxyfluoride species, not as segregated oxyfluoride species.

The DTA/TGA data shows that the addition of DEA to the YBCO solution dramatically effects the thermal decomposition behavior. Attempts to isolate single crystals of the products of the DEA addition, in order to understand the underlying chemistry, were not successful due to the high solubility of the compounds formed in DEA and the lack of compound solubility in other typical solvents used to enable crystallization. However, a single crystal analog of the likely Cu compound was crystallized from solutions by using pyridine as an additional solvent. The strong Lewis-basic nature of pyridine allows it to replace other weakly coordinated species (i.e., DEA). Therefore, the location of the hexagonal-shaped pyridine molecules on the Cu metal center indicate likely coordination sites for the DEA solvent molecules. This assumption is supported by a comparison of Fourier-transform infrared (FTIR) spectra of Cu-fluoroacetate to Cu-fluoroacetate/DEA samples, which showed significant shifts in the carboxylate and DEA stretches, implying that the DEA binds to the Cu metal center.

The structure of the pyridine adduct suggests that the Cu-DEA compound has a greater molecular weight than the Cu-fluoroacetate alone, which would decrease its volatility. Further, the bidentate nature of the DEA molecule would favor bridging interactions (i.e., oligimerizaton), which would further increase the compound molecular weight, thereby reducing volatility. To form stoichiometric YBa₂Cu₃O_{7-δ} films, solutions without DEA require a Cu-fluoroacetate excess of about 10 mol %, while the DEA containing solutions only require about 3 mol % excess Cu in order to yield films with Y:Ba:Cu=1:2:3.

Three effects of DEA addition seem to promote film quality. First, coordination of DEA along with the Cu-fluoroacetate appears to suppress Cu sublimation, enabling more reproducible Y:Ba:Cu=1:2:3 stoichiometry. Second, the presence of the DEA diminishes the exothermic nature of the Cu-fluoroacetate decomposition, such that the catalysis of Y— and Ba-fluoroacetate decomposition occurs separately at 320-400° C. instead of 240° C., coincident with the Cu-fluoroacetate pyrolysis. Third, the high-boiling point of DEA (268° C.) enables film stress relaxation, and smoother, lower stress films. The combination of these three effects appears to enable very rapid pyrolysis of YBCO precursor films in air. This has permitted about 2 m/min. continuous dip-coating of YBCO precursor films in air on buffered metal tapes, without need for long pyrolysis ramp times, low pO₂ atmospheres, or water vapor to control film pyrolysis.

The J_{c} values of films pyrolyzed for less than 120 s are almost a constant 3 MA/cm² and 25 MA/cm² at 77° and 7° K, respectively. J_{c} decreases for pyrolysis times greater than 120 s. For 180 s pyrolysis, there is a 30% decrease in J_{c} to less than 2 MA/cm² at 77° K. Films crystallized following a 300 s pyrolysis further decrease in J_{c} to 0.9 MA/cm² at 77° K (a 70% drop). These results are consistent with the formation and increasing density of a-axis oriented YBCO grains with longer pyrolysis times, as discussed previously.

Two primary issues with fabricating YBCO coated conductors using CSD approaches are processing time and film thickness. The methods described herein can be used to dramatically reduce the pyrolysis stage to seconds from multiple hours. With such a short pyrolysis stage, ex situ solution deposition, as a process for making coated conductors, can now be directly compared with other ex situ deposition methods, such as sputtering and e-beam, and in situ processes, such as pulsed laser deposition, where the deposition/crystallization stages are the most time intensive parts of coated conductor fabrication.

There still exists a need for solution deposition methods for depositing and crystallizing thick (>1 μm), high-quality layers of complex oxides such as YBCO. YBCO film thickness can be increased by using multilayers. The methods described herein, however, can allow for each of the layers to be thicker and to be grown faster.

Very rapid pyrolysis enables rapid multilayering of YBCO. Films may be pyrolyzed to 325° C. for 20 s prior to application of one ore more subsequent layers. J_{c} values≧2 MA/cm² are measured in single coating films up to 350 nm thick, and linear increases in current are observed in multilayer samples with total film thicknesses up to 1.5 m.

According to some embodiments, a high viscosity compound can be added to the solution preparation to allow the production of thicker films. Non-limiting examples of high viscosity compounds include polyvinylpyrolidone (PVP), trishydroxymethylethane (THME), 1,3-propanediol, polymethylmethacrylate (PMMA), bishydroxymethylpropionic acid, polyethyleneglycol (PEG) and ethyl cellulose. The high viscosity compounds desirably have a high melting point, are easily decomposed, and have a relatively low reactivity.

According to some embodiments, relatively thick films can be produced using a chemical solution-based deposition (CSD) process. For example, a precursor solution for a YBCO film can be prepared by dissolving a barium (Ba) metal-organic compound in a halogenated organic solvent and then adding a yttrium (Y) metal-organic compound and a copper (Cu) metal-organic compound. The organic portion of any of the metal-organic compounds can be, but is not limited to, a carboxylate, neodeconate, alkoxide, amide, acetylacetate, tartrate, citrate, lactone, aldehyde, amine, or hydroxyether. Examples of halogenated solvents include, but are not limited to, primary, secondary and tertiary alcohols, ketones, aliphatic ketones, aromatic hydrocarbons, heterocyclics, hydroxyethers, glycol, and carboxylic acids, where one or more of the bound hydrogen atoms is replaced with a halogen atom, such as fluorine, bromine, iodine, or chlorine. The halogenated organic solvent can be an acid such as TFA. As the solvent is removed from a CSD film during the deposition process, the film becomes more rigid as a gel network forms.

Once the gel network is established, the film cannot easily adjust to external or internal stresses. In the case of the low partial-pressure O₂process described by Dawley et al., the highest stress state likely occurs when the Cu loss from the film is highest, due to Cu precursor volatility. A high-boiling point solvent, such as diethanolamine (b.p. 247° C.), triethanolamine (b.p. 335° C.) and glycerine (b.p. 290° C.) can then be added to prevent the formation of the pencil maze structure to produce smooth, shear films after the pyrolysis. Various lower-boiling-point solvents can optionally be added to the YBCO solution, including solvents with boiling points less than approximately 230° C., such as methanol (b.p. 68° C.), ethanolamine (b.p. 171° C.), acetylacetone (b.p. 141° C.), ethylene glycol (b.p. 198° C.), formamide (b.p. 211° C.) and propanediol (b.p. 213° C.).

In all cases, when a solvent was added with a boiling point less than 230° C., the pencil maze structure resulted. When a solvent with a boiling point greater than 230° C. was added, a smooth, shear film structure resulted. In one embodiment, the high-viscosity compound is then added to produce a thin-film precursor solution. The precursor solution was then deposited on a substrate, heated to dry and pyrolyzed in air during a second heat-treatment. A crystallization anneal was performed to convert the YBCO film to the desired perovskite phase to prepare films with a thickness greater than 100 nm.

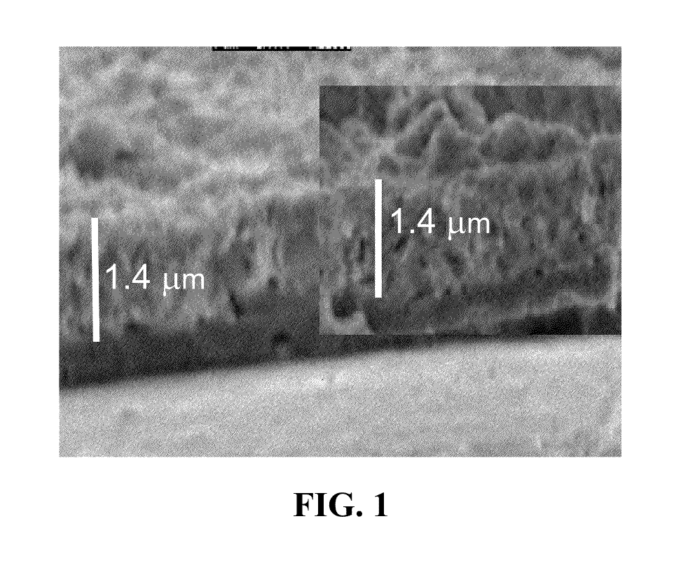

According to some embodiments, the precursor solution can be distilled to remove the halogenated organic solvent and any other low-boiling solvents (e.g., solvents having a boiling point <230° C.) including water. The resulting gel can then be re-dissolved in an organic solvent, such as an alcohol, and the high-viscosity compound can be added. Optionally, further reduction in film stresses can be achieved by adding another solvent with a higher boiling point than DEA, such as triethanolamine. As previously described, the solution can then be deposited on a substrate, dried, pyrolyzed and annealed to prepare YBCO films with thickness up to more than 1-2 microns. FIG. 1 shows an electron microscope image of a 1400-nm thick c-axis YBCO film made from a DEA-containing solution on a SrTiO₃ coated NiW substrate.

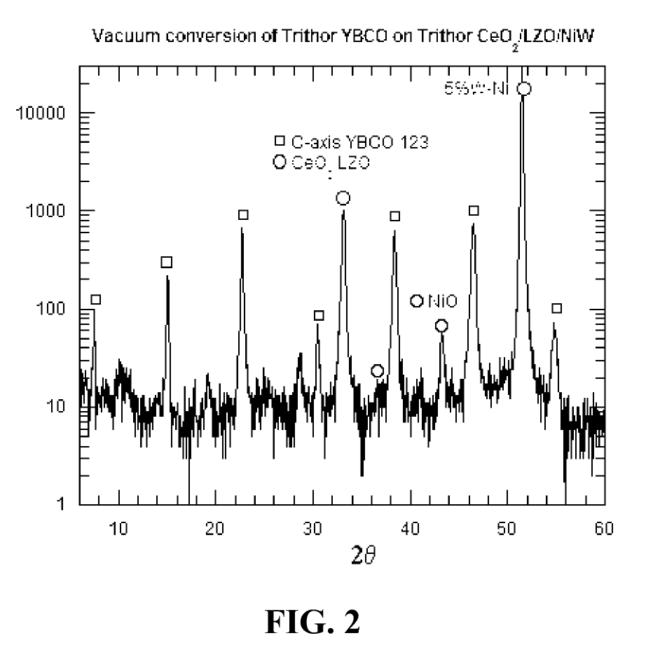

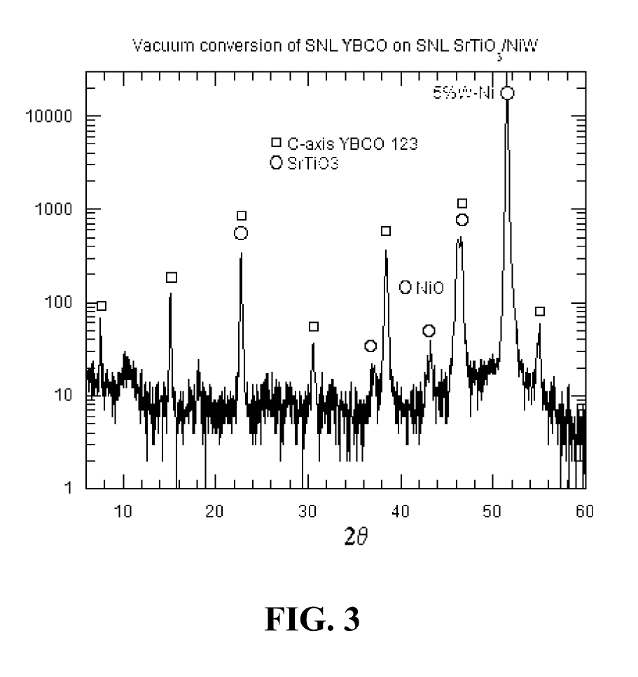

Using continuous dip-coating and annealing the described method can yield highly orientated YBCO-films on various buffer layer architectures on metallic substrate tape as shown in FIGS. 2 and 3. FIG. 2 shows an x-ray diffraction file of a vacuum crystallized, TFA-DEA-Acetone precursor-derived epitaxial YBCO film on a CeO₂/La₂Zr₂O₇ coated Ni_{0.95}W_{0.05} substrate. FIG. 3 shows an x-ray diffraction file of a vacuum crystallized, TFA-DEA-Acetone precursor-derived epitaxial YBCO film on a SrTiO₃-coated Ni_{0.95}W_{0.05} substrate, where both the YBCO and SrTiO3 film were coated at 30 meters/hour.

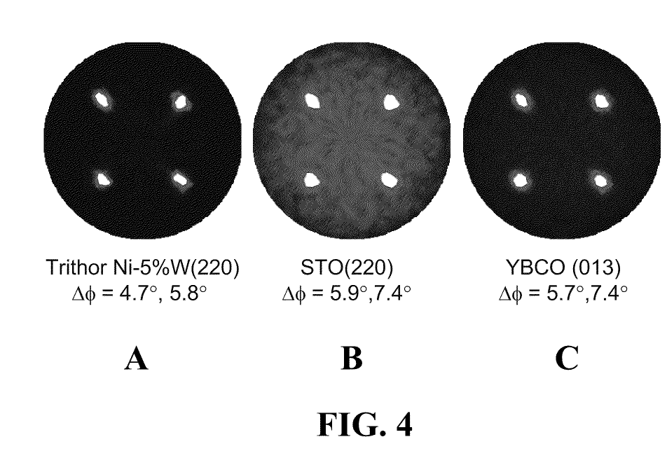

FIGS. 4A, 4B and 4C show x-ray diffraction pole figures illustrating biaxial texture of NiW substrates (FIG. 4A) and subsequent SrTiO₃ (FIG. 4B) and YBCO (FIG. 4C) films. The YBCO films have a J_{c} of greater than 0.5 MA/cm². The films are polycrystalline films with preferred in-plane and out-of-plane grain orientation. In the case of YBCO for coated conductors, the c-axis [(001) planes] of the YBCO grow parallel to the surface of the substrate. The a and b axes of each individual grain are also aligned with each neighboring grain. This type of texture provides for the most efficient grain-to-grain transfer of electrical current.

### EXAMPLES

Aspects of the present teachings may be further understood in light of the following examples, which should not be construed as limiting the scope of the present teachings in any way.

### Example 1

### YBCO Film-Low pO₂ Pyrolysis with DEA Additive

YBCO solutions were prepared by dissolving Ba acetate (99% pure) in TFA at 60-70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine (DEA) and 2-propanol were added to form a 0.3 M solution. Solution preparation was completed by dilution to <0.3 M with 2-propanol to control film thickness. A typical solution synthesis took approximately 30 minutes, compared with over 12 hours required for standard published TFA-based routes (see McIntyre et al., 1992).

YBCO solutions were deposited onto (100) LaAlO₃ (LAO) and (100) SrTiO₃-buffered (100) Ni substrates. The film deposition process generally involves flooding the substrate surface with the YBCO precursor solution through a 0.2 micron filtered syringe and then spinning off the excess solution. The spin conditions for the films deposited on (100) LAO and buffered (100) Ni were approximately 4000 rpm for approximately 30 s. The coated substrates were heated to approximately 100-125° C. to dry. A series of as-deposited films were pyrolyzed in a furnace with a pyrolysis temperature of approximately 250-400° C. and pO₂ of 0.2%-100% O₂/balance N₂. The isothermal hold time and ramp rate were 0 to 20 minutes and 3 to 10 ° C./min, respectively. The time for the pyrolysis step was approximately 1-1.5 hr. The crystallization anneal to 800° C. was optimized for strong flux pinning in 0.1 micron thick YBCO films. Films with a thickness from 100 to 400 nm were prepared. The absolute pressure for the pyrolysis and crystallization runs was kept at atmospheric pressure (630 torr). Transport J_{c} values up to 4×10⁶ A/cm² were obtained on various substrates. The entire processing time was approximately 3.0-3.5 hours. The film deposition, pyrolysis and crystallization parameters can be varied by those skilled in the art and maintain production of high quality films.

### Example 2

### YBCO Film—Rapid Pyrolysis in Air with DEA Additive

YBCO solutions were prepared by dissolving Ba acetate (99% pure) in TFA at 60-70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine and 2-propanol was added to form a 0.3 M solution. Solution preparation was completed by dilution to <0.3 M with 2-propanol to vary the final film thickness. A typical solution synthesis took approximately 30 minutes, compared with over 12 hours required for standard published TFA-based routes (see McIntyre, et al., 1992)

YBCO solutions were deposited onto (100) LaAlO₃ (LAO) and (100) SrTiO₃-buffered (100) Ni substrates. The film deposition process generally involves flooding the substrate surface with the YBCO precursor solution through a 0.2 micron filtered syringe and then spinning off the excess solution. The spin conditions for the films deposited on LAO and buffered (100) Ni were approximately 4000 rpm for approximately 30 s. The coated substrates were heated to 100-125° C. to dry. A second heat-treatment at 300-400° C. for 20-300 seconds in air served as the pyrolysis stage. The crystallization anneal to 800° C. was optimized for strong flux pinning in 0.1 micron thick YBCO films. Films with a thickness from 100 to 400 nm were prepared. The absolute pressure for the crystallization runs was kept at atmospheric pressure (630 torr). Transport J_{c} property values up to 4×10⁶ A/cm² were obtained on various substrates. The entire processing time was approximately 1.5-2.0 hours. The film deposition, pyrolysis and crystallization parameters can be varied by those skilled in the art and maintain production of high quality films.

### Example 3

### 0.25 μm YBCO Films—Rapid Pyrolysis in Air with DEA and PVP Additives

YBCO solutions were prepared by dissolving Ba acetate (99% pure) in TFA at 60-70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine and then 2-propanol or acetone were added to make an approximately 0.3 M solution. Polyvinylpyrolidone (PVP) was then added to increase the viscosity of the solution and to provide a means to relieve film stresses. A typical solution synthesis took approximately 30 minutes.

YBCO solutions were deposited onto <100> LaAlO₃ (LAO), CeO₂/YSZ/Y₂O₃/Ni/Ni—W, and <100> SrTiO₃-buffered <100> Ni/Ni—W substrates. The film deposition process generally involves flooding the substrate surface with the YBCO precursor solution through a 0.2 micron filtered syringe and then spinning off the excess solution. The spin conditions for the films deposited on LAO and buffered metal tapes were approximately 4000 rpm for approximately 30 s. The coated substrates were heated to 100-125° C. to dry. A second heat-treatment at 300-400° C. for 20-300 seconds in air served as the pyrolysis stage. The crystallization anneal to 740-825° C. in 10-1000 ppm O₂ was performed to convert the YBCO films to the desired perovskite phase. Films with a thickness from 100 to 250 nm were prepared. The absolute pressure for the crystallization runs was kept at atmospheric pressure (630 torr). Transport J_{c} property values up to 4×10⁶ A/cm² were obtained on various substrates. The entire processing time was approximately 2.0-3.0 hours. The film deposition, pyrolysis and crystallization parameters can be varied by those skilled in the art and maintain production of high quality films.

### Example 4

### >0.25 μm YBCO Films—Rapid Pyrolysis in Air with DEA and PVP Additives

YBCO solutions were prepared by dissolving Ba acetate (99% pure) in TFA at 60-70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine was added to the solution. The solution was then distilled to remove the TFA and other low boiling solvents, such as water. The removal of said solvents results in the formation of a bluish gel. The gel is then redissolved with methanol, and polyvinylpyrolidone (PVP) is added to increase the viscosity of the solution and to provide a means of relieveing film stresses. Further reduction in film stresses can be achieved by adding a solvent with a higher boiling point than DEA, such as triethanolamine.

YBCO solutions were deposited onto <100> LaAlO₃ (LAO), CeO₂/YSZ/Y₂O₃/Ni/Ni—W, and <100> SrTiO₃-buffered <100> Ni/Ni—W substrates. The film deposition process generally involves flooding the substrate surface with the YBCO precursor solution through a 0.2 micron filtered syringe and then spinning off the excess solution. The spin conditions for the films deposited on LAO and buffered metal tapes were approximately 4000 rpm for approximately 30 s. The coated substrates were heated to 100-125° C. to dry. A second heat-treatment at 300-400° C. for 20-300 seconds in air served as the pyrolysis stage. The crystallization anneal to 740-825° C. in 10-1000 ppm O₂ was performed to convert the YBCO films to the desired perovskite phase. Films with a thickness from 0.25-2.1 μm were prepared. Transport J_{c} property values up to ˜2×10⁶ A/cm² were obtained on various substrates. The film deposition, pyrolysis and crystallization parameters can be varied by those skilled in the art and maintain production of high quality films.

### Example 5

### YBCO Film—Rapid Pyrolysis in Air with DEA Additive in Continuous Coating Device on Buffered Metal Tapes

YBCO solutions were prepared by dissolving Ba acetate (99% pure) in TFA at 60 to 70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine and 2-propanol was added to form a 0.3 M solution. Solution preparation was completed by dilution to <0.3 M with 2-propanol to vary the final film thickness. A typical solution synthesis took approximately 30 minutes, compared with over 12 hours required for standard published TFA-based routes (McIntyre et al., 1992).

The film deposition process is performed in a continuous coating device comprising two winding units, a coating unit and a heating unit for drying and pyrolysis. As a substrate, a buffered metal substrate tape (width 10 mm, thickness 0.8 mm) is used. The biaxial textured metal substrate tape consists of a Ni—W-alloy (5 at % W), the buffer layer system consists of two Lanthanum zirconate layers (each 130 nm in thickness) and one Cerium oxide layer (30 nm in thickness). The Cerium oxide can be doped with up to 10 at % Copper to decrease surface roughness and to increase layer density.

The substrate tape is coated by a dip coating technique by feeding the tape though a coating bath with Teflon wheels with a speed of 50 m/h. After coating the tape moves though a heating zone with a homogeneous temperature profile of 300° C. over 1.2 m length. Thus the pyrolysis time is approximately 60 s. The atmosphere is the heating zone is 20% oxygen in wet nitrogen with a dew point for water of 5° C.

A crystallization anneal to 800° C. was optimized for strong flux pinning in 0.2 micron thick YBCO films. The absolute pressure for the crystallization runs was kept at atmospheric pressure (630 torr). Transport J_{c} property values up to 4×10⁶ A/cm² were obtained on various substrates. The entire processing time was approximately 1.5-2.0 hours. The film deposition, pyrolysis and crystallization parameters can be varied by those skilled in the art and maintain production of high quality films.

### Example 6

### YBCO Film—Rapid Pyrolysis in Air with DEA Additive in Continuous Coating Device on Buffered Metal Tapes with Two Coatings

YBCO solutions were prepared by dissolving Ba acetate (99% pure) in TFA at 60-70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine and 2-propanol was added to form a 0.3 M solution. Solution preparation was completed by dilution to <0.3 M with 2-propanol to vary the final film thickness. A typical solution synthesis took approximately 30 minutes, compared with over 12 hours required for standard published TFA-based routes (see McIntyre et al., 1992).

The film deposition process is performed in a continuous coating device comprising two winding units, a coating unit and a heating unit for drying and pyrolysis. As a substrate buffered metal substrate tape (width 10 mm, thickness 0.8 mm) is used. The biaxial textured metal substrate tape consists of a Ni—W-alloy (5 at % W), the buffer layer system consists of two Lanthanum zirconate layers (each 130 nm thickness) and one Cerium oxide layer (30 nm thickness). The Cerium oxide can be doped with up to 10 at % Copper to decrease surface roughness and to increase layer density.

The substrate tape is coated by a dip coating technique by feeding the tape though a coating bath with Teflon wheels with a speed of 50 m/h. After coating the tape moves though a heating zone with a homogeneous temperature profile of 300° C. over 1.2 m length. Thus the pyrolysis time is approximately 60 s. The atmosphere is the heating zone is 20% Oxygen in wet Nitrogen with a dew point for water of 5° C.

After the first coating and pyrolysis the tape is coated and pyrolysed a second time with the same process parameters and the same coating solution. The second coating and annealing resulted in a nearly doubled layer thickness.

The crystallization anneal to 800° C. was optimized for strong flux pinning in 0.4 micron thick YBCO films. The absolute pressure for the crystallization runs was kept at atmospheric pressure (630 torr). Transport J_{c} property values up to 4×10⁶ A/cm² were obtained on various substrates. The entire processing time was approximately 2.0-2.5 hours. The film deposition, pyrolysis and crystallization parameters can be varied by those skilled in the art and maintain production of high quality films.

### Example 7

### YBCO Film—Rapid Pyrolysis in Air with DEA Additive in Continuous Coating Device, and Vacuum Crystallization of YBCO on Buffered Metal Tapes with One or Two Coatings

YBCO solutions were prepared by dissolving Ba acetate (99% pure) in TFA at 60-70° C. Y acetate tetrahydrate (99.9% pure) and then anhydrous Cu acetate (99% pure) were added to yield a 0.6 M (mol of YBCO/L) solution with 1:2:3 (Y:Ba:Cu) molar ratios. Diethanolamine and acetone were added to form a 0.3 M solution. Solution preparation was completed by dilution to <0.3 M with acetone to vary the final film thickness. A typical solution synthesis took approximately 30 minutes, compared with over 12 hours required for standard published TFA-based routes (see McIntyre, et al., 1992).

The film deposition process is performed in a continuous coating device comprising two winding units, a coating unit and a heating unit for drying and pyrolysis. As a substrate buffered metal substrate tape (width 10 mm, thickness 0.8 mm) is used. The biaxial textured metal substrate tape consists of a Ni—W-alloy (5 at % W), the buffer layer system consists of three SrTiO₃ layers (300 nm total thickness) grown with cube texture on the Ni—W alloy.

The substrate tape is coated by a dip coating technique by feeding the tape though a coating bath with Teflon wheels with a speed of 30 m/h. After coating the tape moves though a heating zone with a homogeneous temperature profile of 310° C. over 0.5 m length. Thus the pyrolysis time is approximately 60 s. The atmosphere is the heating zone is 20% Oxygen in wet Nitrogen with a dew point for water of 25° C.

A crystallization anneal to 780° C. was optimized for strong flux pinning in 0.35 micron thick YBCO films. The absolute pressure for the crystallization runs was kept at reduced pressure (1 Torr), with a crystallization time of 12 minutes, compared to 1 to 2 hours in the literature. Transport J_{c} property values up to 1.7×10⁶ A/cm² were obtained on various substrates.

Films coated with two layers may be crystallized in 24 minutes (linear relation of film thickness to growth time, suggesting gas flow rate-limited growth) compared to 4 hours in the literature (quadratic relation of film thickness to time, suggesting reactant by-product diffusion-limited growth, x=(2Dt)^{1/2}, where x is film thickness, D is effective diffusion rate, and t is time). The entire processing time was approximately 1.5 hours for single layer films and 2 hours for two-layer films. The film deposition, pyrolysis and crystallization parameters can be varied by those skilled in the art and maintain production of high quality films.

While the foregoing specification teaches the principles of the present invention, with examples provided for the purpose of illustration, it will be appreciated by one skilled in the art from reading this disclosure that various changes in form and detail can be made without departing from the true scope of the invention.

1. A composition comprising:
a barium metal-organic compound;
one or more rare earth metal-organic compounds;
a copper metal-organic compound;
a high-boiling solvent having a boiling point greater than 230° C. at atmospheric pressure;
wherein the composition further comprises a halogenated organic solvent and/or wherein one or more of the barium metal-organic compound, the one or more rare earth metal-organic compounds and the copper metal-organic compound comprises a halogen;
wherein the molar ratio of high-boiling solvent to rare earth metal in the composition is 1-10:1; and
wherein the molar ratio of barium to rare earth metal in the composition is less than 2.1:1 and wherein the molar ratio of copper to barium in the composition is greater than 3:2.

2. The composition of claim 1, wherein the one or more rare earth metal-organic compounds comprises a yttrium metal-organic compound.

3. The composition of claim 1, wherein the molar ratio of high boiling solvent to rare earth metal in the composition is 2-3:1.

4. The composition of claim 1, further comprising a low-viscosity solvent having a viscosity of less than 10 centipoise at 20° C.

5. The composition of claim 4, wherein the low-viscosity solvent is acetone.

6. The composition of claim 4, wherein the composition comprises a halogenated organic solvent and wherein the low-viscosity solvent does not react with the halogenated organic solvent to form H₂O.

7. The composition of claim 1, wherein the high-boiling solvent is diethanolamine.

8. The composition of claim 7, wherein the copper metal-organic compound is a complex of copper and diethanolamine.

9. The composition of claim 8, wherein the barium metal-organic compound is barium trifluoroacetate, the rare earth metal-organic compound is a rare earth trifluoroacetate.

10. The composition of claim 8, wherein the composition does not include a halogenated organic solvent.

11. The composition of claim 1, wherein the barium metal-organic compound is a barium acetate, the one or more rare earth metal-organic compounds are one or more rare earth metal-acetates, wherein the copper metal-organic compound is a copper acetate and wherein the composition comprises a halogenated organic solvent.

12. The composition of claim 11, wherein the halogenated organic solvent is trifluoroacetic acid.

13. The composition of claim 1, wherein the molar ratio of halogen to barium in the composition is 6-180:1.

14. The composition of claim 13, wherein the molar ratio of halogen to barium in the composition is 35-45:1.

15. The composition of claim 1, wherein the molar ratio of copper to barium in the composition is 3-3.8:2.

16. The composition of claim 1, wherein the molar ratio of barium to rare earth metal in the composition is 2:1-1.5.

17. The composition of claim 4, wherein the molar ratio of low-viscosity solvent to barium in the composition is 1-75:1.

18. The composition of claim 4, wherein the molar ratio of low-viscosity solvent to barium in the composition is 15-35:1.

19. The composition of claim 1, wherein the composition comprises a halogenated organic solvent and wherein the halogenated organic solvent is selected from the group consisting of halogenated primary, secondary and tertiary alcohols, halogenated ketones, halogenated aliphatic ketones, halogenated aromatic hydrocarbons, halogenated heterocyclics, halogenated hydroxyethers, halogenated glycols, and halogenated carboxylic acids.

20. The composition of claim 4, wherein the low-viscosity solvent is selected from the group consisting of alcohols, ketones, aromatic hydrocarbons, heterocyclic compounds, hydroxyethers and glycols.

21. The composition of claim 1, wherein the high-boiling solvent is selected from the group consisting of diethanolamine, triethanolamine, and glycerine.

22. The composition of claim 1, wherein the composition further comprises an agent which increases the viscosity of the composition.

23. The composition of claim 22, wherein the agent which increases the viscosity of the composition is selected from the group consisting of polyvinylpyrolidone (PVP), trishydroxymethylethane (THME), 1,3-propanediol, polymethylmethacrylate (PMMA), bishydroxymethylpropionic acid, polyethylene glycol (PEG), and ethyl cellulose.

24. A method of making a rare earth metal Ba₂Cu₃O_{7-δ} film wherein 6 is 0 to 1 inclusive, comprising:
a) coating a composition of as set forth in claim 1 onto a substrate;
b) subsequently heating the composition at a rate of at least 50° C./minute to cause organic decomposition thereby forming a pyrolyzed precursor on the substrate;
c) subsequently reacting the pyrolyzed precursor into a rare earth metal Ba₂Cu₃O_{7-δ} film.

25. The method of claim 24, wherein reacting the pyrolyzed precursor into a rare earth metal Ba₂Cu₃O_{7-δ} film comprises reacting the pyrolyzed precursor at a pressure of less than 1 atmosphere or at a pressure of less than 0.1 atmosphere.

26. The method of claim 24, further comprising repeating a) and b) at least one time to form multiple pyrolyzed precursor layers on the substrate prior to reacting the pyrolyzed precursor into a rare earth metal Ba₂Cu₃O_{7-δ} film.

27. The method of claim 24, wherein the substrate is selected from the group consisting of doped or undoped aluminates, titanates, zirconates, manganates, niobates, rare earth oxides, magnesium oxide, Ni, NiW, NiWMg, Ag, Cu, and combinations thereof.

28. The method of claim 24, wherein the substrate is selected from the group consisting of (100) LAO, (100) SrTiO₃-buffered (100) Ni, MgO, Ho₂O₃, Gd₂O₃, Er₂O₃, CeO₂, La₂Zr₂O₇, La_{0.7}Sr_{0.3}MnO₃, BaZrO₃, CeO₂, NaNbO₃, Y₂O₃-ZrO₂, III-V nitrides, Ni, Ag, and Cu.

29. The method of claim 24, wherein coating the composition onto the substrate comprises dip-coating, aerosol misting, spraying or printing the composition onto the substrate.

30. The method of claim 29, wherein coating the composition onto the substrate comprises ink-jet printing or screen printing.

31. The method of claim 24, wherein heating the composition to cause organic decomposition comprises heating the composition to a temperature less than 400° C. for less than 300 seconds.

32. The method of claim 24, wherein the step of reacting the pyrolyzed precursor into a rare earth Ba₂Cu₃O_{7-δ} film comprises heating the pyrolyzed precursor to a temperature less than 900° C.

33. The method of claim 24, wherein heating the composition to form a pyrolyzed precursor and reacting the pyrolyzed precursor into a rare earth Ba₂Cu₃O_{7-δ} film are performed in less than 30 minutes.

34. The method of claim 24, wherein the rare earth Ba₂Cu₃O_{7-δ} film has a thickness greater than approximately 100 nm.

35. The method of claim 24, wherein the rare earth Ba₂Cu₃O_{7-δ} film has a transport J_{c} value at 77° K greater than approximately 1×10⁶ A/cm².
